(19) United States
(12) Patent Application Publication
(10) Pub. No.: US 2003/0117417 A1
(43) Pub. Date: Jun. 26, 2003

(54) Generic application flow management system and method

(75) Inventor: Dalsu Lee, Thornhill (CA)

Correspondence Address: HAYNES AND BOONE, LLP, 901 MAIN STREET, SUITE 3100, DALLAS, TX, 75202, US

(73) Assignee: Nortel Networks Limited, St. Laurent (CA)

(21) Appl. No.: 10/027,945

(22) Filed: Dec. 20, 2001

(51) Int. Cl. G09G 5/00

(52) U.S. Cl. 345/619

(57) ABSTRACT

A generic application flow management system and method according to which an import module imports an object and an application builder having a graphical interface displays the object as icons. The icons are capable of being positioned relative to each other. A generation module generates a script using the object represented by the first icon and the object represented by the second icon, wherein the relative position of the first icon to the second icon indicates the flow of the script.

### SYSTEM AND METHOD

1. Field of the Invention

The present invention relates generally to the generation of computer programs, and more particularly to the generation of scripts using generic objects.

### BACKGROUND OF THE INVENTION

The generation of computer programs is a complicated and often difficult process for even the most expert computer programmer. One factor attributing to the complexity is the syntax and structure of many computer programming languages. One effort to overcome these complexities was the advent of object oriented programming. In object oriented programming, an “object” is a self-contained set of computer code that has certain properties and methods. The methods permit a programmer to access the computer code within the object without having to know the details of the computer code, and without having to recreate the computer code each time that functionality is desired. This provides a layer of abstraction so that a programmer needs only to know the general functionality of an object, rather than the inner workings of the computer code that performs the object's functionality. Further, because the properties and methods of objects are self-contained, objects can often be used and re-used for multiple applications and multiple purposes without additional programming.

One of the drawbacks of an object oriented system, such as C++ or Sun Microsystems' Java, is that the source code of the computer program must be compiled before the computer program can be executed. Once a program has been compiled, the only way that the flow (i.e. the order in which the program executes) can be altered is to make the changes and then recompile the program. This results in programs that are often difficult to update and maintain.

On the other hand, programs made from scripts do not require compilation. Scripts are computer programs that are interpreted on a line-by-line basis at run-time. Because scripts are generally linear in their application flow, a script is easier to understand and maintain than programs compiled using object oriented programming. However, scripts, unlike objects, are often specific to certain applications and generally cannot be used for multiple purposes.

Accordingly, a problem exists in that object oriented programming provides certain benefits to the programmer developing a computer application, but object oriented programming does not have the run-time benefits of scripts.

Therefore, what is needed is a system and method for combining the abstraction capabilities of object oriented programming with the execution at run-time capabilities of scripts. What is also needed is a method to facilitate the creation of computer programs combining the generic application flow of scripts with the abstraction of objects.

### SUMMARY OF THE INVENTION

Provided is a unique system and method for building a generic application flow management system. In one embodiment, the method comprises importing an object into an application builder having a graphical user interface. The method displays the object as a first icon and a second icon in the graphical user interface, wherein a first icon can be positioned relative to a second icon. A script is generated from the first icon and the second icon, wherein the relative position of the first icon to the second icon indicates the flow of the application. In another embodiment, the methods of the imported object are displayed as icons in the graphical user interface. In yet another embodiment, the sub-objects of the imported object are displayed in the graphical user interface.

### DESCRIPTION OF THE DRAWINGS

FIG. 1A is an illustration of an exemplary embodiment of the invention including an application builder.

FIG. 1B is a schematic illustration of an exemplary application platform for use with one embodiment of the present invention.

FIG. 2 is an illustration of an exemplary embodiment of a computer for use with one embodiment of the present invention.

FIG. 3 is a flowchart illustrating the operation of an embodiment of the invention.

FIG. 4 is an illustration of an embodiment of the application builder of FIG. 1 during operation.

FIG. 5 is a further illustration of an embodiment of the application builder during operation.

FIG. 6 is another illustration of an embodiment of the application builder during operation.

FIG. 7 is an illustration of an example script.

FIG. 8 is a flowchart illustrating the operation of another embodiment of the invention.

### DETAILED DESCRIPTION

The present invention provides a unique method and system for building and using a generic application flow management system. It is understood, however, that the following disclosure provides different embodiments and examples, for implementing different features of the invention. Specific examples of components, signals, messages, protocols, and arrangements are described below to simplify the present disclosure. These are, of course, merely examples and are not intended to limit the invention from that described in the claims. Well-known elements and procedures are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

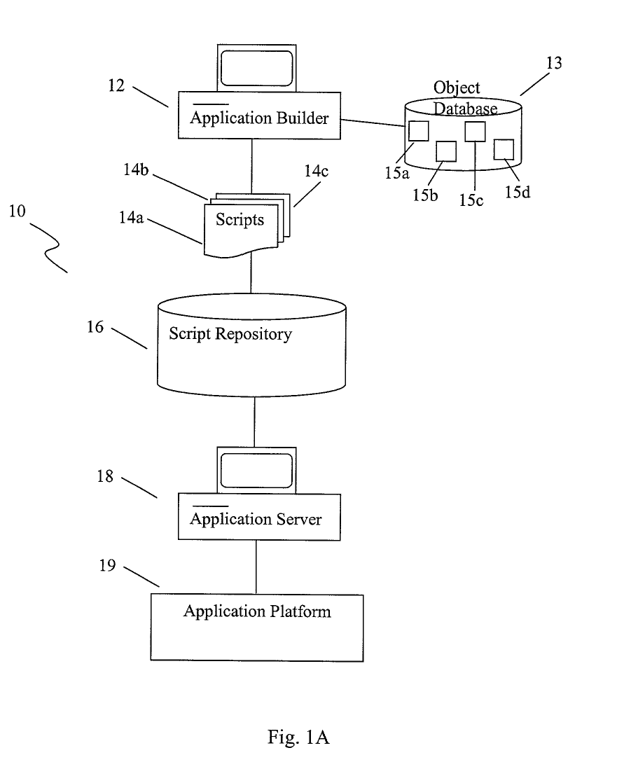

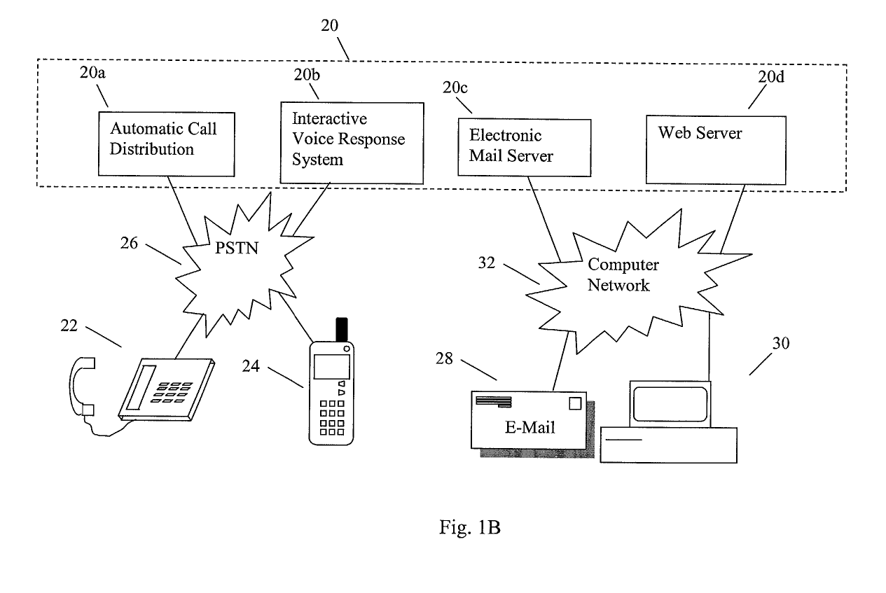

Turning now to FIG. 1A, a generic application flow management system and method according to an embodiment of the present invention, is referred to, in general, by the reference number 10. The embodiment 10 comprises an application builder 12, which can be a software program that allows a user, such as a computer programmer, to access computer code for objects. The application builder 12 can access an object database 13 in order to generate a plurality of scripts, which are represented as scripts 14a-14c. The scripts 14a-14c are stored in a script repository 16. The script repository 16 is accessible by an application server 18 for executing a script (e.g., the script 14a), which will be discussed in more detail below. While three scripts 14a-14c are shown in this example, it is understood that the script repository 16 could contain a plurality of scripts.

A plurality of objects, such as objects 15a, 15b, 15c, and 15d, are stored in the object database 13. The objects 15a-15d are self-contained entities of computer code that consist of programming elements, such as data, procedures, variables, or methods. In one embodiment, objects can be created from Java or the Java 2 Platform Enterprise Edition (J2EE), as well as Distributed Component Object Model (DCOM) objects, as would be understood by those skilled in the art. As an example, Java objects are Java class files that are compiled output files of Java source files, while DCOM objects are dynamically linked libraries (e.g. “.dll” files) that are compiled output files of C/C++ source code files.

The object database 13 can be an object library, object containers, or a standard database. The object database 13 is accessible such that the application builder 12 can import one or more objects 15a-15d. Objects are often used in object oriented programming, which is a method of programming that is a collection of interacting, but largely independent, software components (e.g. objects). In object oriented programming, once a program is written, the objects used in the program generally need to be compiled before it can be executed.

Scripts 14a-14c are stored in the script repository 16. Scripts generally are text files written in a specific format that comprise a series of commands that are executed in a linear fashion. Unlike objects 15a-15d, scripts 14 generally do not need to be compiled before execution, but are interpreted during execution.

Once the scripts 14a-14c have been generated, they may now be accessed by an application server 18, which is a software application that is capable of executing the commands contained in scripts 14a-14c. The application server 18 can be coupled to any form of application platform 19, which can be any form of a hardware and/or software system. As an example, the application platform 19 could be a computer server or telecommunications switching system in a customer service center, such as switch system 20 is illustrated in FIG. 1B.

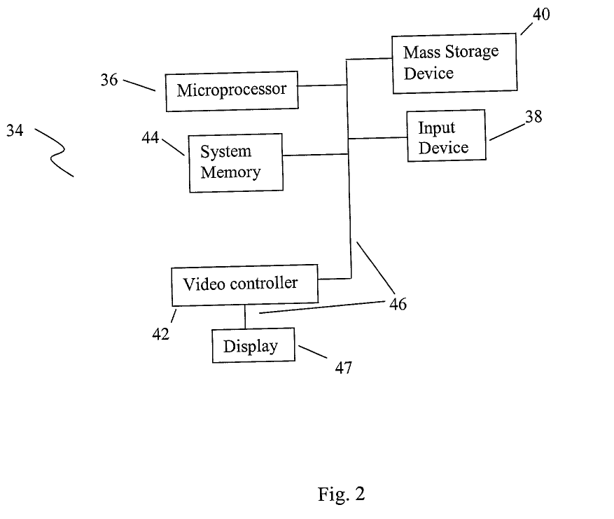

To provide some example scenarios in which the present invention may be employed, referring now to FIG. 2B, the switching system 20 might include an automatic call distribution (ACD) system 20a for handling and routing of telephone calls, an interactive voice response (IVR) system 20b for providing preliminary customer service, an electronic mail server 20c for handling and routing of electronic mail, and a web server 20d for providing information and receiving requests from customers.

A telephone 22 might connect to the ACD system 20a via a public switched telephone network (PSTN) 26. The telephone 22 could also connect to the IVR system 20b over the PSTN 26. A mobile phone 24 could also connect to the ACD system 20a or the IVR system 20b over the PSTN 26. Also in this example, customers could also use e-mail 28 or a computer 30 to access the electronic mail server 20c and the web server 20d over a computer network 32. The computer network 32 could be the internet, an intranet, or a series of internal or external networks, or any combination thereof. The e-mail 28 could be transmitted by any form of a remote node, including any web-enabled device, computer, laptop computer, or personal digital assistant. The computer 30 could also be any form of a remote node.

Referring now to FIG. 2, reference numeral 34 indicates a computer that may be used to run the application builder 12 (FIG. 1). It is understood that the application builder 12 and application server 18 could each be executed on a single computer or executed across multiple computers in communication with each other via any form of network. The illustrative computer 34 includes a microprocessor 36, an input device 38, a storage device 40, a video controller 42, and a system memory 44, all interconnected by one or more buses 46. A display device 47 is also included, connected to the video controller 42 via the bus 46. The storage device 40 could be a floppy drive, hard drive, CD-ROM, optical drive, or any other form of storage device. In addition, the storage device 40 may be capable of receiving a floppy disk, CD-ROM, DVD-ROM, or any other form of computer-readable medium that may contain computer-executable instructions. Thus, instructions for implementing the embodiment illustrated in FIG. 1A could be stored on the storage device 40 and read into the system memory 44 before executing the embodiment. In one embodiment, the computer 34 would have an operating system, such as Microsoft Windows NT, Unix, or Linux. In a further embodiment, the application builder 12 and application server 18 would be created using the Java programming language.

Building a Script Repository:

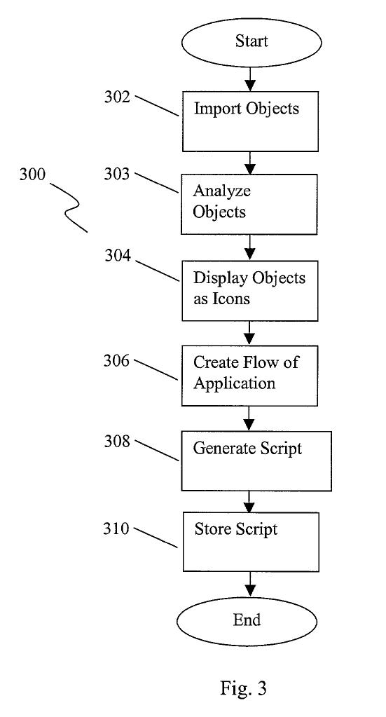

FIG. 3 shows a method 300 which illustrates one embodiment of the process of building a script repository 16. Execution begins at step 302, where the application builder 12 (FIG. 1A) imports from the object database 13 an object (e.g., 15d), or multiple objects, as the case may be, that contains the basic desired functionality of an application platform. Generally, the user of the application builder 12 initiates the importing by selecting which object(s) are to be imported, but the application builder 12 may also be capable of importing all of the available objects automatically or may be preset to import certain objects at certain times, or any other method as would be understood by those skilled in the art. In step 303, the application builder 12 analyzes the imported object or objects for any sub-objects (e.g. objects programmed within the original imported objects) as well as for any other programming elements. In step 304, the application builder 12 then displays the imported object as icons on a display device. Each sub-object, or other programming elements, may also be depicted as an icon on the display device.

After the imported object has been displayed as icons, in step 306, parameters may be input and the icons can be manipulated to create the desired application flow. Once the icons have been placed to represent the desired flow of operation for the application, a script is generated by the application builder 12 by analyzing the relative positions of the icons, step 308. This analysis will be discussed in more detail below. The application flow is stored as a script in the script repository, step 310. The script may then be executed, when called by the application server 18, which will be discussed in further detail below.

As an example of the method 300, the ACD system 20a will be discussed. For this example, the application builder 12 will import the object 15d, which contains all of the pre-programmed methods and procedures that might be used in the ACD system 20a, such as: (1) methods for placing a telephone caller on hold, (2) hanging up the phone, (3) providing music to the caller while on hold, and (4) ringing the original caller back.

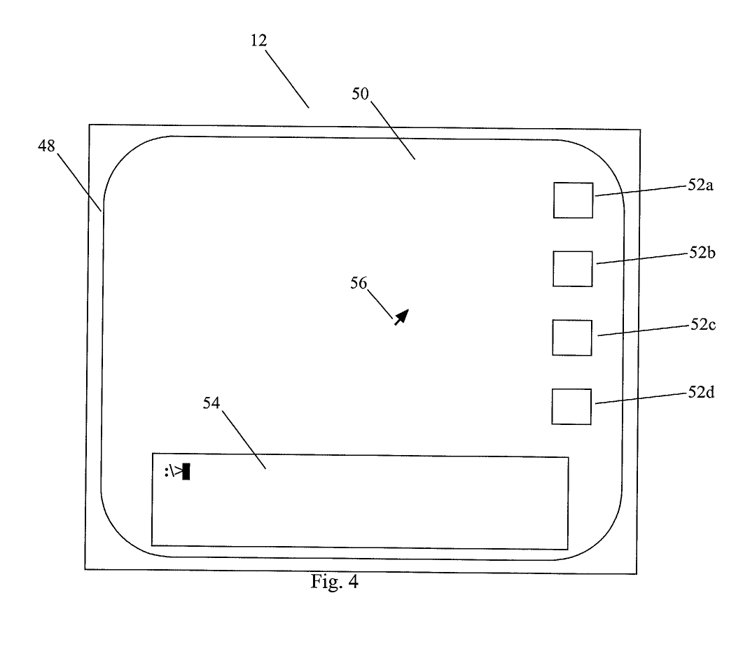

FIG. 4 depicts a possible interface of the application builder 12 with a display screen 48. As mentioned above, in this illustrative example, the object 15d has been imported from the object database 13 into the application builder 12. In this example, the object 15d comprises four methods, and these four methods are depicted in a graphical user interface (GUI) 50 as icons 52a, 52b, 52c, and 52d.

The icon 52a represents a method of the ACD object 15d called “giveRingBack”, which includes the program code for ringing the original telephone caller back if no connection is established. The icon 52b represents a method of the ACD object 15d called “putOnHold” which includes the program code for maintaining a telephone connection from a caller until a desired recipient is available. The icon 52c represents a method of the ACD object 15d called “hangUp” which includes the program code for terminating a telephone call, and the icon 52d represents a method of the ACD object 15d called “giveMusic” which includes the program code for providing music to a telephone caller. Although the icons 52a -52d are aligned along the right hand side of GUI in this example, alternative embodiments may include placing the icons into groups, hierarchical menu systems, GUI stacks (i.e. one icon “on top” of another), or GUI shelves (i.e. icons representing similar objects are grouped together and can be moved about the GUI as a group), as well as in other GUI implementations as would be understood by those of ordinary skill in the art.

The GUI 50 also may contain a command line interface 54 and a pointer 56 for receiving input from a user, such as a computer programmer. The pointer 56 may be a mouse, trackball, touch-screen device, or any other form of input device.

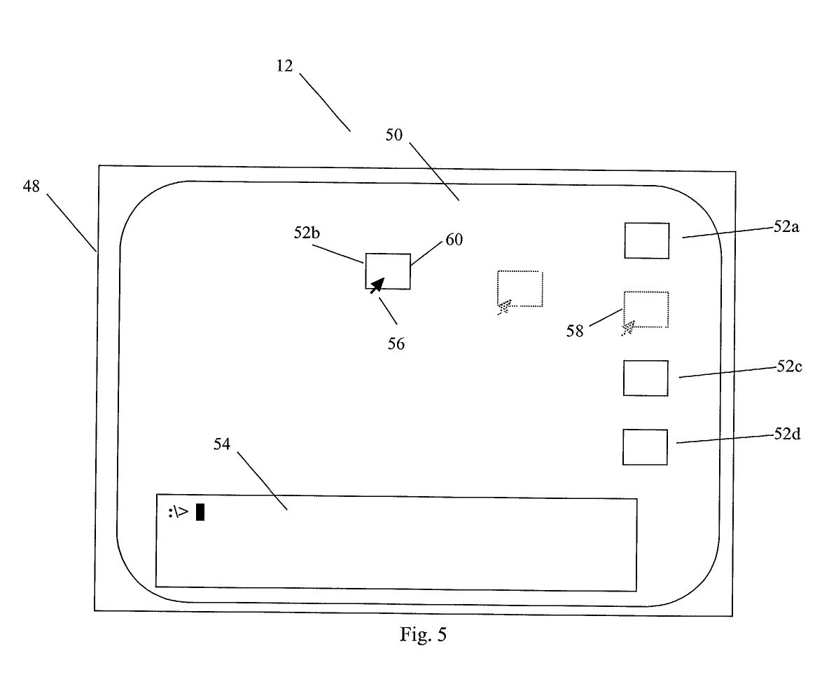

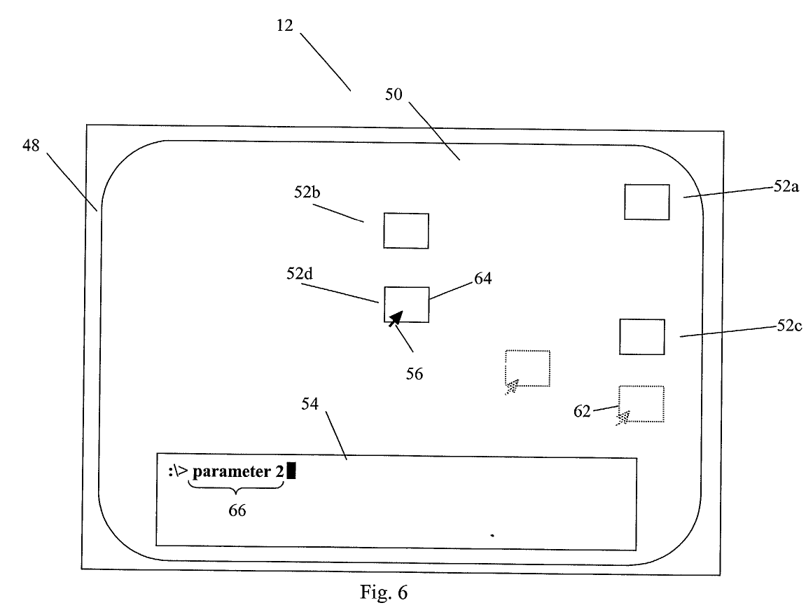

FIG. 5 illustrates a situation where a user, such as computer programmer, has used the pointer 56 to move the icon 52b from position 58 to position 60 on the GUI 50. In FIG. 6, the computer programmer has used the pointer 56 to manipulate the icon 52d from position 62 to position 64. In addition, in this example, the computer programmer has elected to provide a parameter value 66 for the object represented by the icon 52d by using the command line interface 54. It is understood that alternate methods of providing parameter values could be used, such as each icon displaying parameters associated with the object associated with the icon, or a submenu could be associated with the icon, or other methods as are commonly known in the art.

As shown in FIGS. 4-6, the method of determining the application flow is using a top to bottom prioritization analysis. Since the icon 52b is “above” icon 52d, icon 52b will be “first” in the application flow. Alternatively, the application builder 12 may be capable of permitting the user to designate a number value to each icon, or provide a mechanism to draw directional lines in the GUI 50 to indicate the flow. Additionally, the application builder 12 could use a left to right analysis, or any method of analyzing the relative position of one icon to another icon.

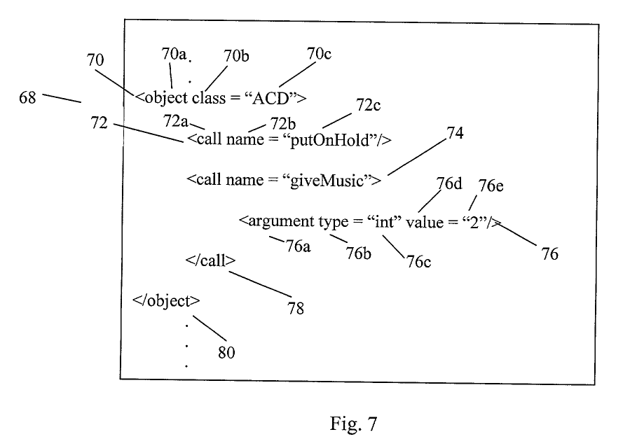

FIG. 7 is an example script 68 generated using the ACD system 20a operational flow depicted in FIGS. 4-6. While the application builder 12 is capable of generating scripts in different formats compatible with a variety of scripting languages, including XML (extensible markup language), JavaScript and VBScript, for purposes of illustration, script 68 was generated using a markup language commonly referred to as extensible markup language (XML).

Since, in the ACD system 20a example, the imported object contained functionality for an ACD system, the application builder 12 creates script command 70, comprising a tag 70a, indicating “object”; attribute 70b, indicating “class”; and value 70c, indicating “ACD”. The “first” icon in the application flow was the icon 52b, representing the “putOnHold” method. In this example, the “first” icon was determined using a top-down analysis. Since the icon 52b was above icon 52d, then icon 52b is considered to be “first.” Therefore, the application builder places script command 72 into the script. Script command 72 comprises tag 72a, indicating that a method is to be called; an attribute 72b indicating the name of the method; and value 72c, providing that the name of the method is “putOnHold”. Likewise, the “second” icon was the icon 52d, representing the “giveMusic” method, so the application builder places script command 74 into the script. Since the computer programmer provided a parameter value of “2” for icon 52b, the application builder 12 creates script command 76, comprising a tag 76a of “argument”, indicating that a parameter will be sent to the called method; attribute 76b, indicating that the parameter will have a type; value 76c, indicating that the parameter will be an integer; attribute 76d; and value 76e, indicating that the parameter is “2”. Then, because no additional methods were provided, script command 78 is placed into the script, indicating that script command 74 is complete. While script command 78 is included to indicate that script command 74 is completed, it is not necessary to provide a similar command for script command 72, in this instance, because no parameters were provided for the “putOnHold” method of script command 72. Similarly, the application builder 12 provides script command 80 to indicate that no additional methods are being called from object ACD (i.e. script command 70). It is understood that multiple objects could be used in a single script.

Using the Script Repository:

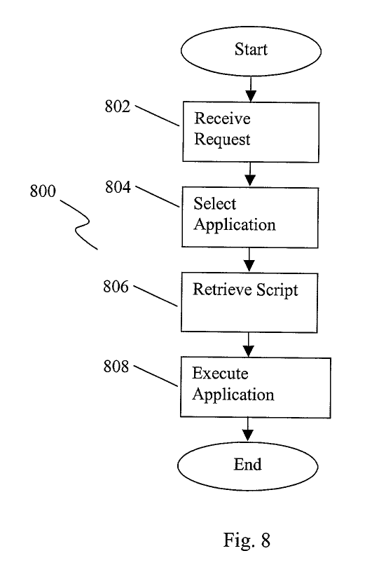

FIG. 8 shows a method 800 which illustrates one embodiment of the process of using a script stored in script repository 16. Execution begins at step 802, where the application server 18 (FIG. 1A) receives a request from the application platform. A request could be receipt of a telephone call, the receipt of an email, a “hit” to a web site, or any form of receipt of data or communication at the application server 18. As a result of the request, the application server 18 selects the appropriate application to process the request, step 804. For example, in the case of an email, the appropriate application might be a program to analyze the subject of the email to determine whether it is a service request or product order.

In step 806, the application server 18 then retrieves the script that corresponds to the desired application by providing the operational flow of the application. The application server then begins to interpret the script and can execute the application using a virtual machine that calls the methods and objects designated in the script, step 808.

As an example of the method 800, the ACD system 20a will be discussed, using the script 70 as an illustration. Assume an action occurs from the application platform 19 (e.g. a phone call is received from the telephone 22 at the ACD system 20a) so that a request is generated. In response to the request, the application server 18 determines the applicable software application to process the request. The application server 18 then accesses the script from the script repository 16 which corresponds to the application software application. The application server 18 then executes the script.

In one embodiment, the application server 18 interprets the script 14 and uses a virtual machine to call the methods and objects in the script 14. A virtual machine is a self-contained operating environment that behaves like a computer, but does not utilize the operating system of the computer on which the virtual machine is running in order to execute a program. In another embodiment, a virtual machine might use reflection, which is a technique used by a virtual machine to access and use objects during execution, rather than compiling the objects into the application. An example virtual machine that uses reflection is provided by Sun Microsystems' Java. In Java, reflection enables Java code to discover information about the fields, methods and constructors of loaded classes, and to use reflected fields, methods, and constructors to operate on their underlying counterparts on objects, within security restrictions.

In any event, the script 68 is retrieved by the application server 18 from the script repository 16. In this example, the application server 18 is running a virtual machine with reflection capabilities. Script 68, as depicted in FIG. 7, is interpreted (or parsed) by the application server 18. The application server 18 interprets script command 70 and tells the virtual machine to instantiate the ACD object 15d. The application server 18 next interprets script command 72 and instructs the virtual machine to call the method “putOnHold.” The virtual machine uses reflection to access the “putOnHold” method in the instantiated ACD object. The application server 18 then interprets script command 74 and instructs the virtual machine to call the method “giveMusic”. The application server interprets tag 76a, attribute 76b, value 76c, attribute 76d, and value 76e, and provides an integer value of “2” to the method “giveMusic”. The application server then interprets script command 78 and knows that no additional parameters are to be sent to the “giveMusic” method.

The virtual machine then uses reflection to access the “giveMusic” method and passes the parameter “2” to the instantiated ACD object. The application server 18 interprets script command 80 and knows that no additional method calls are to be made to the ACD object. The result of this example is a telephone call being placed on hold and hold music being provided for a unit of time (e.g. minutes) of 2.

The application server 18 may also have a registry of objects in order to easily and quickly refer to objects that are called from scripts 14. The application server 18 also may permit the suspension of the operating threads. Operating threads can be suspended when activity for that specific script is not needed at a given time, and then resumed when the activity is to continue. As an example, a script handling email can suspend when the email reaches a mailbox, and then resume when the email is read.

While the invention has been particularly shown and described with reference to the preferred embodiments thereof, it will be understood by those skilled in the art that various changes in form and detail may be made therein without departing from the spirit and scope of the invention, as set forth in the following claims.

What is claimed is:

1. A method for building a generic application comprising:
importing an object into an application builder having a graphical user interface;
displaying the object as at least two icons in the graphical user interface, wherein a first icon of the at least two icons can be positioned relative to a second icon of the at least two icons; and
generating a script representing the first icon and the second icon, wherein the relative position of the first icon to the second icon indicates the a of the script.

2. The method of claim 1, wherein the generating further comprises generating the script using a markup language.

3. The method of claim 1, wherein the generating further comprises generating the script using an extensible markup language.

4. The method of claim 1, further comprising executing the script.

5. The method of claim 4, wherein the executing further comprises executing the script using a virtual machine with reflection.

6. A system for building a generic application, comprising:
an import module for importing an object;
an application builder having a graphical interface for displaying the object as at least two icons, wherein a second icon of the at least two icons can be positioned relative to a first icon of the at least two icons; and
a generation module for generating a script, wherein the relative position of the first icon to the second icon indicates a flow of the script.

7. The system of claim 6 wherein the object is programmed in a non-script programming language.

8. The system of claim 6, further comprising a script repository for storing a plurality of scripts.

9. The system of claim 6, further comprising an application server for executing the script.

10. The system of claim 6, wherein the object is comprised of at least two programming elements, and wherein the at least two icons correspond to the at least two programming elements.

11. The system of claim 10, wherein the at least two programming elements are sub-objects.

12. The system of claim 10, wherein the at least two programming elements are methods.

13. The system of claim 6, wherein the object provides functionality for an automatic call distribution system.

14. The system of claim 6, wherein the object provides functionality for an interactive voice response system.

15. The system of claim 6, wherein the object provides functionality for an electronic mail system.

16. The system of claim 6, wherein the object provides functionality for a website server.

17. A method for facilitating the operation of an application platform comprising:
receiving a request at an application server;
selecting an application to process the request;
retrieving a script from a script repository, such that the script represents an operational flow of the selected application; and
executing the selected application at the application server by interpreting the script and using a virtual machine with reflection.

18. A computer-readable medium having computer-executable instructions for performing a method comprising:
instructions for importing an object that is comprised of a first method and a second method into an application builder having a graphical user interface, wherein the object is programmed in an object oriented programming language;
instructions for displaying the first method as a first icon and the second method as a second icon in the graphical user interface;
instructions for positioning the second icon relative to the first icon in the graphical user interface;
instructions for generating an extensible markup language script from the methods corresponding to the first icon and the second icon, wherein the relative position of the first icon to the second icon indicates the position of the first method relative to the second method in a flow of the script; and
instructions for storing the script.

19. The computer readable medium of claim 18 further comprises instructions for executing the script on an application server.

20. The computer readable medium of claim 19 wherein the instructions for executing the script further comprises a virtual machine using reflection.
